(19) United States
(12) Patent Application Publication
(10) Pub. No.: US 2025/0281870 A1
(43) Pub. Date: Sep. 11, 2025

(54) ADSORBENT FOR HYDROCARBON RECOVERY WITH IMPROVED MECHANICAL PROPERTIES

(71) Applicant: BASF CORPORATION, Florham Park, NJ (US)

(72) Inventors: Robert LEPSKI, Nienburg/Weser (DE); Nele KLINKENBERG, Nienburg/Weser (DE); Joerg NAGY, Nienburg/Weser (DE); Tobias ECKARDT, Nienburg/Weser (DE); William B. DOLAN, Iselin, NJ (US)

(21) Appl. No.: 18/861,939

(22) PCT Filed: Apr. 28, 2023
(86) PCT No.: PCT/US2023/020379

§ 371 Date: Oct. 31, 2024

Related U.S. Application Data
(60) Provisional application No. 63/338,384, filed on May 4, 2022.

(51) Int. Cl. B01D 53/04

(52) U.S. Cl. CPC B01D 53/0462; B01D 2253/104; B01D 2253/106; B01D 2257/702; B01D 2257/80

(57) ABSTRACT

Disclosed in certain embodiments are adsorbents with improved mechanical properties for capturing heavy hydrocarbons during, for example, via thermal swing adsorption processes.

### CROSS-REFERENCE TO RELATED APPLICATION(S)

This application claims the benefit of priority of U.S. Provisional Patent Application No. 63/338,384, filed May 4, 2022, the disclosure of which is hereby incorporated by reference herein in its entirety.

### BACKGROUND

Hydrocarbons are commonly removed from natural gas to prevent the condensation of liquids in pipeline transmission systems. Pipelines commonly impose a dew point specification to prevent the condensation of the liquids, with hydrocarbon recovery units (HRUs) being utilized to remove heavy hydrocarbons in particular.

Silica-based adsorbents have an affinity for heavy hydrocarbons, such as C5+ components, and may be used in HRUs. In such systems, a fluid volume (e.g., natural gas) containing heavy hydrocarbons is passed through a bed of silica gel to trap heavy hydrocarbons. Regeneration may be performed by passing a pressurized and/or heated stream of natural gas feed or product gas through the adsorbent bed. After cooling, the heavy hydrocarbons contained in the effluent from the regeneration process can be condensed as a liquid product and removed. In order to improve the adsorptive efficiency of such systems, there is a need to explore the use of other adsorbent materials that exhibit higher affinities for heavy hydrocarbons.

### SUMMARY OF THE DISCLOSURE

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

One aspect of the present disclosure relates to adsorbent particles comprising amorphous silica.

In at least one embodiment, a relative micropore surface area (RMA) of the adsorbent particles is at least about 15%, and a total pore volume of the adsorbent particles for pores between 500 nm and 20000 nm in diameter, as measured via mercury porosimetry, is less than 5 mm³/g.

In at least one embodiment, a relative micropore surface area (RMA) of the adsorbent particles is at least about 15%, and an average crush strength of the adsorbent particles is greater than about 60 N/bead.

In at least one embodiment, a relative micropore surface area (RMA) of the adsorbent particles is at least about 15%, and a tapped bulk density of the adsorbent particles is greater than 0.6 g/cm³.

In at least one embodiment, a relative micropore surface area (RMA) of the adsorbent particles is at least about 15%, and a tapped bulk density of the adsorbent particles is greater than 0.6 g/cm³ and a total pore volume of the adsorbent particles for pores between 500 nm and 20000 nm in diameter, as measured via mercury porosimetry, is less than 200 mm³/g.

In at least one embodiment, the total pore volume for pores between 500 nm and 20000 nm in diameter, as measured via mercury porosimetry, is less than about 4 mm³/g, less than about 3 mm³/g, less than about 2 mm³/g, less than about 1 mm³/g, less than about 0.5 mm³/g, or less than about 0.1 mm³/g.

In at least one embodiment, the tapped bulk density of the adsorbent particles is at least 0.65 g/cm³, at least about 0.7 g/cm³, at least about 0.75 g/cm³, at least about 0.8 g/cm³, at least about 0.9 g/cm³, or at least about 1.0 g/cm³.

In at least one embodiment, the RMA of the adsorbent particles is at least about 20%, at least about 25%, or at least about 30%.

In at least one embodiment, the adsorbent particles have a fluid-accessible average Brunauer-Emmett-Teller (BET) surface area of at least about 600 m²/g, at least about 700 m²/g, at least about 800 m²/g, at least about 900 m²/g, or at least about 1000 m²/g.

In at least one embodiment, an average diameter of the adsorbent particles is greater than about 1 mm, greater than about 2 mm, greater than about 3 mm, greater than about 4mm, or from about 2 mm to about 4 mm.

In at least one embodiment, the adsorbent particles comprises SiO₂, on average, in an amount of at least about 80 wt. %, at least about 85 wt. %, at least about 90 wt. %, at least about 95 wt. %, or at least about 99 wt. %, or at least about 99.9 wt. % or at least about 99.99 wt. % based on a total weight of the adsorbent particles.

In at least one embodiment, the adsorbent particles further comprise alumina.

Another aspect of the present disclosure relates to a system configured to treat a fluid volume. In at least one embodiment, the system comprises an adsorbent bed comprising the adsorbent particles of any of the preceding claims.

In at least one embodiment, the system is a thermal swing adsorption system.

In at least one embodiment, the thermal swing adsorption system is adapted for adsorption of water and/or C5+or C6+components from a fluid volume. In at least one embodiment, the C5+ or C6+ components comprise one or more of pentane, hexane, benzene, heptane, octane, nonane, toluene, ethylbenzene, xylene, or neopentane.

Another aspect of the present disclosure relates to a natural gas purification system comprising an adsorbent bed comprising the adsorbent particles of any of the preceding embodiments.

Another aspect of the present disclosure relates to an adsorbent bed comprising the adsorbent particles of any of the preceding embodiments.

Another aspect of the present disclosure relates to a method of treating a fluid volume comprising an initial concentration of C5+ or C6+ components, the method comprising contacting the fluid volume with the adsorbent particles of any of the preceding embodiments. In at least one embodiment, the C5+ or C6+ components comprise one or more of pentane, hexane, benzene, heptane, octane, nonane, toluene, ethylbenzene, xylene, or neopentane. In at least one embodiment, the C5+ or C6+ components comprise one or more of n-C6, n-C7, n-C8, n-C9, or benzene.

### BRIEF DESCRIPTION OF THE DRAWINGS

The present disclosure is illustrated by way of example, and not by way of limitation, in the figures of the accompanying drawings, in which:

FIG. 1 depicts an illustrative adsorbent bed in accordance with an embodiment of the disclosure;

FIG. 2 illustrates a method for removing heavy hydrocarbons from a fluid volume in accordance with an embodiment of the disclosure; and

FIG. 3 shows breakthrough plots for various inventive and comparative adsorbents.

### DETAILED DESCRIPTION

The present disclosure relates generally to an adsorbent for improved purification of gas streams, and a system incorporating the adsorbent and method of use thereof. More specifically, the present disclosure relates to an adsorbent used for the removal of heavy hydrocarbons (e.g., C5+ or C6+ components), water, acid gases, or other chemical species and the recovery of heavy hydrocarbons by use of an integrated process.

The adsorption process of the present disclosure, used to remove heavy hydrocarbons (e.g., C5+ or C6+ components) or other components (e.g., water) from gas feed streams (e.g., a natural gas feed streams) may be accomplished by thermal swing adsorption (TSA). TSA processes are generally known in the art for various types of adsorptive separations. Generally, TSA processes utilize the process steps of adsorption at a low temperature, regeneration at an elevated temperature with a hot purge gas, and a subsequent cooling down to the adsorption temperature. TSA processes are often used for drying gases and liquids and for purification where trace impurities are to be removed. TSA processes are often employed when the components to be adsorbed are strongly adsorbed on the adsorbent, and thus heat is required for regeneration.

A typical TSA process includes adsorption cycles and regeneration (desorption) cycles, each of which may include multiple adsorption steps and regeneration steps, as well as cooling steps and heating steps. The regeneration temperature is higher than the adsorption temperature in order to effect desorption of water, methanol, and heavy hydrocarbons. To illustrate, during the first adsorption step, which employs an adsorbent for the adsorption of C5+ or C6+ components from a gas stream (e.g., a raw natural gas feed stream), the temperature is maintained at less than 150° F. (66° C.) in some embodiments, and from about 60° F. (16° C.) to about 120° F. (49° C.) in other embodiments. In the regeneration step of the present disclosure, water and the C5+or C6+components adsorbed in the adsorbent bed initially are released from the adsorbent bed, thus regenerating the adsorbent at temperatures from about 300° F. (149° C.) to about 550° F. (288° C.) in some embodiments.

In the regeneration step, part of one of the gas streams (e.g., a stream of natural gas), the product effluent from the adsorber unit, or a waste stream from a downstream process can be heated, and the heated stream is circulated through the adsorbent bed to desorb the adsorbed components. In some embodiments, it is advantageous to employ a hot purge stream comprising a heated raw natural gas stream for regeneration of the adsorbent.

In some embodiments, the pressures used during the adsorption and regeneration steps are generally elevated at typically 700 to 1500 psig. Typically, heavy hydrocarbon adsorption is carried out at pressures close to that of the feed stream and the regeneration steps may be conducted at about the adsorption pressure or at a reduced pressure. When a portion of an adsorption effluent stream is used as a purge gas, the regeneration may be advantageously conducted at about the adsorption pressure, especially when the waste or purge stream is re-introduced into the raw natural gas stream, for example.

While embodiments of the present disclosure are described with respect to natural gas purification processes, it is to be understood by those of ordinary skill in the art that the embodiments herein may be utilized in or adapted for use in other types of industrial applications that require heavy hydrocarbon and/or water removal in addition to LGN and natural gas liquid (NGL) applications.

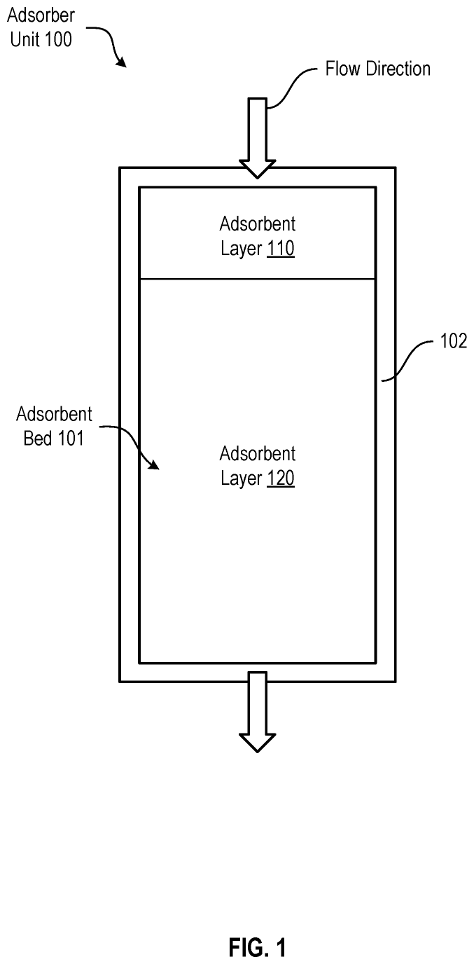

FIG. 1 illustrates an adsorber unit 100 in accordance with an embodiment of the disclosure, which may be adapted for use in a TSA process. In some embodiments, the adsorber unit 100 includes a single vessel 102 that houses an adsorbent bed 101. Other embodiments may utilize multiple vessels and adsorbent beds, for example, when implementing a continuous TSA process where one or more adsorbent beds are subject to an adsorption cycle while one or more beds are subject to a regeneration cycle. For example, the adsorber unit 100 may include, in some embodiments, two or more vessels and adsorbent beds that are duplicates of the vessel 102 and the adsorbent bed 101 (not shown). While the adsorbent bed 101 is subjected to an adsorption cycle, a duplicate adsorbent bed is subjected to a regeneration cycle, for example, using a product gas resulting from the adsorption cycle performed with the adsorbent bed 101.

The adsorbent bed 101 includes an adsorbent layer 110 and an adsorbent layer 120 each contained inside a vessel 102. The flow direction indicates the flow of a gas feed stream through an inlet of the vessel 102, through the adsorbent layer 110, and then through the adsorbent layer 120, before reaching an outlet of the vessel 102. The adsorbent layer 120 is said to be downstream from the adsorbent layer 110 based on this flow direction. In some embodiments, each adsorbent layer may comprise their respective adsorbents in a form of adsorbent beads having diameters, for example, from about 1 mm to about 5 mm. The relative sizes of the adsorbent layers is not necessarily drawn to scale, though in certain embodiments a weight percent (wt. %) of the adsorbent layer 120 with respect to a total weight of the adsorbent bed 101 (i.e., a total weight of the adsorbent layer 120, the adsorbent layer 110, and any additional layers) may be greater than 50 wt. %, greater than 60 wt. %, greater than 70 wt. %, greater than 80 wt. %, or greater than 90 wt. %. In some embodiments, the adsorbent layer 110 is omitted, and the adsorbent layer 120 is the sole adsorbent layer in the adsorbent bed 101.

In some embodiments, the adsorbent layer 110 comprises a water stable adsorbent, such as Durasorb™ HD (available from BASF), comprising, for example, silica or silica-alumina.

In some embodiments, the adsorbent layer 120 comprises a microporous adsorbent that is preferentially selective for C5+ or C6+ hydrocarbons. As used herein, the terms “preferentially selective for” or “selective for” indicates that the adsorbent adsorbs the specified compound at a greater equilibrium loading compared to methane, further described by the following equation (for C6+): selectivity=(loading C6+/concentration C6+)/(loading C1/concentration C1), where C1 is methane, and where loading is defined as moles of component adsorbed per gram of adsorbent. In certain embodiments, C5+ or C6+ compounds may comprise one or more of pentane, hexane, benzene, heptane, octane, nonane, toluene, ethylbenzene, xylene, or neopentane.

As used herein, the term “microporous adsorbent” refers to an adsorbent material having a relative micropore surface area (RMA), which is the ratio of micropore surface area to Brunauer-Emmett-Teller (BET) surface area, that is at least about 10%, at least about 15%, at least about 20%, at least about 25%, or at least about 30%. A microporous adsorbent may further have one or more of the following properties: a total pore volume for pores between 500 nm and 20000 nm in diameter, as measured via mercury porosimetry, that is at least about 5 mm³/g, at least about 10 mm³/g, at least about 20 mm³/g, at least about 30 mm³/g, at least about 40 mm³/g, at least about 45 mm³/g, or at least about 50 mm³/g, or, alternatively, less than about 5 mm³/g, no more than about 4 mm³/g, no more than about 3 mm³/g, no more than about 2 mm³/g, or no more than about 1 mm³/g; a pore volume (e.g., Barrett-Joyner-Halenda (BJH) pore volume) that is at least about 0.40 cm³/g, is from about 0.40 cm³/g to about 0.50 cm³/g, or from about 0.425 cm³/g to about 0.475 cm³/g; or a BET surface area at least about 400 m²/g, at least about 500 m²/g, at least about 600 m²/g, at least about 700 m²/g, at least about 800 m²/g, or at least about 900 m²/g.

As used herein, “micropore surface area” refers to total surface area associated with pores below 200 angstroms in diameter. In some embodiments, a micropore surface area of the microporous adsorbent is at least about 40 m²/g, at least about 50 m²/g, at least about 100 m²/g, at least about 150 m²/g, at least about 200 m²/g, or at least about 230 m²/g. In some embodiments, the micropore surface area of the microporous adsorbent is from about 40 m²/g to about 300 m²/g, from about 50 m²/g to about 300 m²/g, from about 100 m²/g to about 300 m²/g, from about 150 m²/g to about 300 m²/g, from about 200 m²/g to about 300 m²/g, or from about 230 m²/g to about 300 m²/g. In some embodiments, a relative micropore surface area is from about 5% to about 10%, about 10% to about 15%, about 15% to about 20%, about 20% to about 25%, about 25% to about 30%, or in any range defined therebetween (e.g., about 15% to about 25%). In some embodiments, a corresponding BET surface area of the microporous adsorbent ranges from about 650 m²/to about 850 m²/g.

In some embodiments, the microporous adsorbent comprises silica (SiO₂) at a weight percent at least about 85 wt. %, at least about 90 wt. %, at least about 95 wt. %, at least about 96 wt. %, at least about 97 wt. %, at least about 98 wt. %, at least about 99 wt. %, at least about 99.9 wt. %, or at least about 99.99 wt. wt. %, based on a total weight of the microporous adsorbent. In some embodiments, the microporous adsorbent further comprises alumina (Al₂O₃) at a weight percent of up to 20 wt. % (i.e., from greater than about 0 wt. % to about 20 wt. %), up to about 15 wt. %, up to about 10 wt. %, up to about 9 wt. %, up to about 8 wt. %, up to about 7 wt. %, up to about 6 wt. %, up to about 5 wt. %, up to about 4 wt. %, up to about 3 wt. %, up to about 2 wt. %, or up to about 1 wt. %. In at least one embodiment, one or more of the SiO₂ or the Al₂O₃ (if present) is amorphous (e.g., completely amorphous).

In some embodiments, the total pore volume for pores between 500 nm and 20000 nm in diameter of the microporous adsorbent is at least about 20 mm³/g, at least about 40 mm³/g, at least about 70 mm³/g, at least about 100 mm³/g, at least about 120 mm³/g, at least about 140 mm³/g, at least about 150 mm³/g, at least about 160 mm³/g, or at least about 170 mm³/g. In some embodiments, the total pore volume for pores between 500 nm and 20000 nm in diameter of the microporous adsorbent is from about 20 mm³/g to about 200 mm³/g, from about 40 mm³/g to about 200 mm³/g, from about 70 mm³/g to about 200 mm³/g, from about 100 mm³/g to about 200 mm³/g, from about 120 mm³/g to about 200 mm³/g, from about 140 mm³/g to about 200 mm³/g, from about 150 mm³/g to about 200 mm³/g, from about 160 mm³/g to about 200 mm³/g, from about 170 mm³/g to about 200 mm³/g, or in any range defined therebetween. In some embodiments, the total pore volume for pores between 500 and 20000 nm in diameter of the microporous adsorbent is less than about 5 mm³/g, e.g., no more than about 4 mm³/g, no more than about 3 mm³/g, no more than about 2 mm³/g, no more than about 1 mm³/g, or within any range defined therebetween (e.g., 1 mm³/g to 3 mm³/g). In at least some embodiments, the total pore volume for pores between 500 nm and 20000 nm in diameter of the microporous adsorbent is 0 mm³/g or below a detectable level.

In at least one embodiment, the total pore volume for pores between 500 and 20000 nm in diameter is about 1 mm³/g, about 2 mm³/g, about 3 mm³/g, about 4 mm³/g, about 5 mm³/g, about 6 mm³/g, about 7 mm³/g, about 8 mm³/g, about 9 mm³/g, about 10 mm³/g, about 11 mm³/g, about 12 mm³/g, about 13 mm³/g, about 14 mm³/g, about 15 mm³/g, about 16 mm³/g, about 17 mm³/g, about 18 mm³/g, about 19 mm³/g, about 20 mm³/g, about 21 mm³/g, about 22 mm³/g, about 23 mm³/g, about 24 mm³/g, about 25 mm³/g, about 26 mm³/g, about 27 mm³/g, about 28 mm³/g, about 29 mm³/g, about 30 mm³/g, or within any range defined therebetween (e.g., from about 1 mm3/g to about 20 mm³/g).

In some embodiments, the microporous adsorbent comprises fluid-accessible surface area characterized by a BET surface area from about 400 m²/g to about 1000 m²/g, from about 500 m²/g to about 1000 m²/g, from about 600 m²/g to about 1000 m²/g, from about 700 m²/g to about 1000 m²/g, from about 800 m²/g to about 1000 m²/g, from about 900 m²/g to about 1000 m²/g, or in any range defined therebetween.

In some embodiments, a tapped bulk density of the microporous adsorbent is less than 6 g/cm³. In some embodiments, the tapped bulk density of the microporous adsorbent is at least 0.65 g/cm³, at least about 0.7 g/cm³, at least about 0.75 g/cm³, at least about 0.8 g/cm³, at least about 0.85 g/cm³, at least about 0.9 g/cm³, at least about 0.95 g/cm³, at least about 1.0 g/cm³, or in any range defined therebetween.

In some embodiments, a BJH pore volume of the microporous adsorbent is at least about 0.40 cm³/g, from about 0.40 cm³/g to about 0.50 cm³/g, or from about 0.425 cm³/g to about 0.485 cm³/g.

In some embodiments, the microporous adsorbent is in a form of spherical particles having, for example, an average diameter of at least about 1 mm, at least about 2 mm, at least about 3 mm, at least about 4 mm, from about 2 mm to about 4 mm, or from about 2.5 mm to about 3.5 mm.

In some embodiments, the microporous adsorbent, when in the form of spherical particles or “beads,” exhibits a crush strength of at least about 50 Newtons (N) per bead, at least about 60 N/bead, at least about 70 N/bead, at least about 80 N/bead, at least about 90 N/bead, at least about 100 N/bead, at least about 125 N/bead, at least about 150 N/bead, at least about 175 N/bead, at least about 200 N/bead, at least about 225 N/bead, at least about 250 N/bead, at least about 275 N/bead, or within any range defined therebetween (e.g., from about 70 N/bead to about 200 N/bead). Measurements of crush strength are intended to provide indication of the ability of adsorbent to maintain its physical integrity during handling and use. Crush strength, as discussed herein, was determined in accordance with DIN 8948 (section 7.3) using a tablet hardness tester (e.g., ERWEKA TBH 125). For a given adsorbent, a representative sample of 25 whole beads of varying sizes (from about 2 mm to about 5 mm in diameter) was used. The tablet hardness tester was then used to crush the beads and determine the necessary force. One bead was measured at a time with a compressive force being applied at a rate of 25 N/s and a speed of 2.3 mm/s until the bead was crushed. The crushed bead was then removed, and the process was repeated for each subsequent bead. The average of 25 beads was calculated to obtain the crush strength for a given adsorbent.

In an exemplary embodiment, a microporous adsorbent that could be advantageously utilized, for example, in a TSA process has the following properties: a fluid-accessible BET surface area from about 740 m²/g to about 820 m²/g; a micropore surface area of about 180 m²/g to about 230 m²/g; an RMA from about 22% to about 30%; a BJH pore volume from about 0.42 mL/g to about 0.49 mL/g; a macropore volume (i.e., pore volume for pores having diameters from 500 nm to 20000 nm) of less than 6 mm³/g (e.g., about 5 mm³/g to about 6 mm³/g, less than about 5 mm³/g, or less than 5 mm³/g); a crush strength of greater than about 100 N/bead; a tapped bulk density of about 0.70 kg/L to about 0.8 kg/L; and SiO₂ present in amorphous form at least about 99 wt. % based on a total weight of the microporous adsorbent.

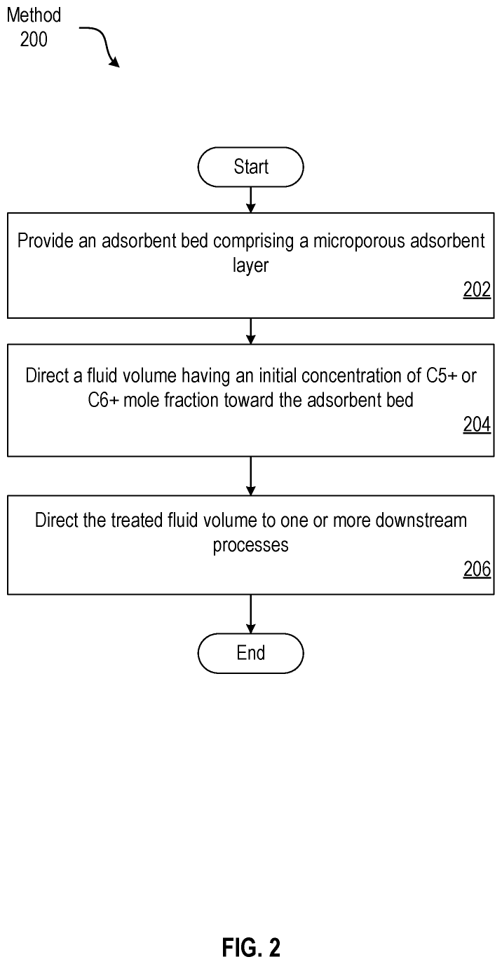

FIG. 2 illustrates a method 200 for removing heavy hydrocarbons (e.g., C5+ or C6+ components) from a fluid volume in accordance with an embodiment of the disclosure. At block 202, an adsorbent bed including a microporous adsorbent in the form of adsorbent particles is provided. In some embodiments, the adsorbent bed corresponds to the adsorbent bed 101 described with respect to FIG. 1. In some embodiments, the adsorbent particles form the adsorbent layer 120 described with respect to FIG. 1. In some embodiments, the adsorbent bed further includes an additional adsorbent layer, such as the adsorbent layer 110.

At block 204, a fluid volume is directed toward and contacted with the adsorbent bed. In some embodiments, the contacting occurs in a thermal swing-adsorption system. The fluid volume may have an initial concentration of C5+ or C6+ components (e.g., a concentration of benzene and/or other components that is greater than 150 ppm). In some embodiments, an initial concentration of one or more of C5+ or C6+ components is greater than 150 ppm, greater than 250 ppm, greater than 500 ppm, greater than 1000 ppm, greater than 2000 ppm, or greater than 3000 ppm. In some embodiments, the initial concentration is from 150 ppm to 4000 ppm, from 250 ppm to 4000 ppm, from 500 ppm to 4000 ppm, from 1000 ppm to 4000 ppm, from 2000 ppm to 4000 ppm, or from 3000 ppm to 4000 ppm.

At block 206, the treated fluid volume is directed to one or more downstream processes. A final concentration of C5+ or C6+ components can be measured for the fluid volume. In some embodiments, the final concentration of one or more of C5+ or C6+ components is less than 30 ppm, less than 20 ppm, less than 10 ppm, less than 5 ppm, less than 4 ppm, less than 3 ppm, less than 2 ppm, or less than 1 ppm. For example, the C5+ or C6+ components may comprise one or more of pentane, hexane, benzene, heptane, octane, nonane, toluene, ethylbenzene, xylene, or neopentane, and/or may comprise one or more of n-C6, n-C7, n-C8, n-C9, or benzene.

### ILLUSTRATIVE EXAMPLES

The following examples are set forth to assist in understanding the disclosure and should not, of course, be construed as specifically limiting the embodiments described and claimed herein. Such variations of the disclosed embodiments, including the substitution of all equivalents now known or later developed, which would be within the purview of those skilled in the art, and changes in formulation or minor changes in experimental design, are to be considered to fall within the scope of the embodiments incorporated herein.

Micropore surface area and BET surface area can be characterized via nitrogen porosimetry using, for example, a Micromeritics ASAP® 2000 porosimetry system. Mercury porosimetry can be performed using, for example, a Thermo Scientific™ Pascal 140/240 porosimeter. An exemplary method for measuring pore volume may be performed according to ASTM D4284-12 (2017)e1, “Standard Test Method for Determining Pore Volume Distribution of Catalysts and Catalyst Carriers by Mercury Intrusion Porosimetry.”

Tapped bulk density, as discussed herein, is measured according to EN ISO 787-11. To measure tapped bulk density of a sample adsorbent, 250 mL of a representative sample was poured into the 250 mL cylinder of a tapping machine (e.g., ERWEKA Tapped Density Tester SVM 12). To pour the sample into the cylinder, a metal funnel was used to ensure that the sample was poured in evenly. The size of the metal funnel depends on the bead size of the sample. Different funnels can be used for different sieve lines (e.g. 2050, 1650, etc.), as described in DIN 8948, section 7.6. The cylinder was placed in the tapping machine and the sample was tapped 600 times. The volume was read off to the nearest 1 mL and the sample mass was determined by weighing. The volume after tapping was divided by the mass of the sample to obtain the tapped bulk density (units of g/cm³).

### Characterization of Adsorbents

Various adsorbents were characterized and are summarized in Table 1 below.

Inventive Examples 1 and 2 are silica-based microporous adsorbents prepared using a conventional oil drop process, as would be understood by those of ordinary skill in the art, which was modified to adjust parameters including BET surface area, micropore surface area, and macropore volume.

Comparative Example 1 is a silica-based microporous adsorbent similar to the compositions described in International Application Publication No. WO 2016205616 A1.

Comparative Example 2 is a silica-based adsorbent available commercially as Sorbead® H (BASF).

Each sample was subjected to a preconditioning procedure involving heating in a range from 170° C. to 250° C. for about three hours.

As shown in Table 1, Inventive Examples 1 and 2 simultaneously exhibit high RMA, high crush strength, and high density, while being substantially free of macropores having diameters from 500 to 20000 nm.

TABLE 1
Adsorbent properties

| | Inventive | Inventive | Comparative | Comparative |
|---|---|---|---|---|
| | Example 1 | Example 2 | Example 1 | Example 2 |
| BET surface | 812 | 743 | 750 | 746 |
| area (m²/g) | | | | |
| Micropore surface | 187 | 218 | 232 | 57 |
| area (m²/g) | | | | |
| RMA (%) | 23 | 29 | 31 | 8 |
| Pore volume, | 0.48 | 0.43 | 0.50 | 0.50 |
| N₂ (mL/g) | | | | |
| Macropore volume, | 4 | 2 | 200 | 4 |
| Hg (mm³/g)* | | | | |
| Crush strength | 62 | 285 | 38 | 251 |
| (N/bead) | | | | |
| Tapped bulk | 0.70 | 0.76 | 0.57 | 0.7 |
| density (kg/L) | | | | |

*For pores with diameters from 500-20000 nm

### Adsorption Tests

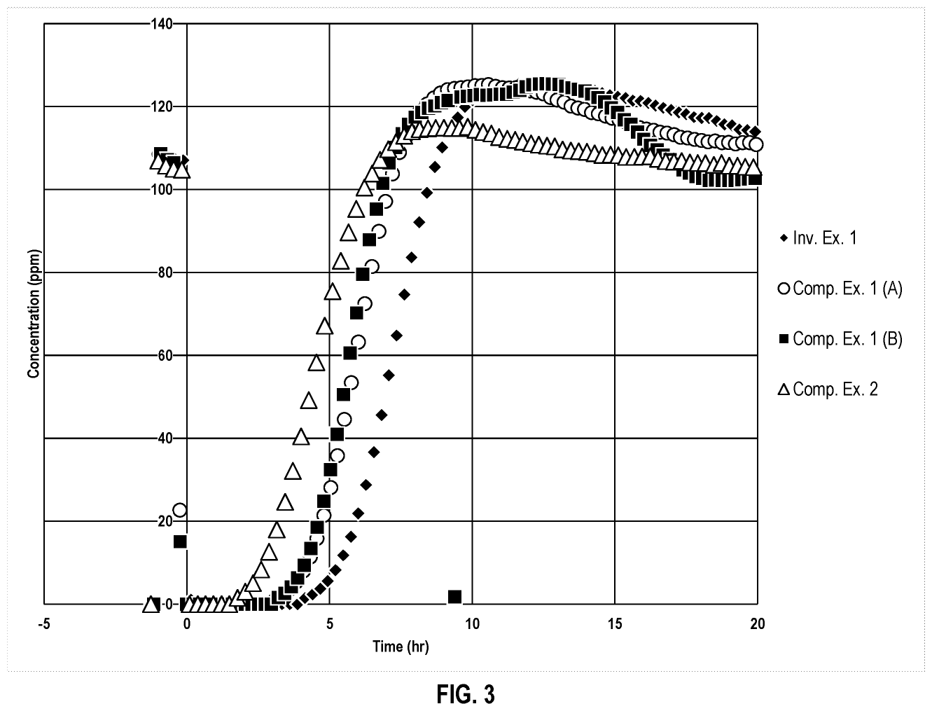

Adsorption beds were prepared for each of Inventive Example 1, Comparative Example 1 (two separate runs indicated as A and B), and Comparative Example 2, with each bed being loaded with 167 cc of its respective adsorbent. Each bed was fed 15.4 slpm of a gas that includes 200 ppm n-C6, 100 ppm n-C7, 50 ppm n-C8, and 50 ppm benzene at a temperature of 25° C. and a pressure of 900 psia. The bed was loaded with 167 cc of the Sorbead H. Gas concentrations were measured at the outlets of the beds, and breakthrough plots were generated and plotted in FIG. 3. Inventive Example 1 demonstrated a longer breakthrough time than the Comparative Examples.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment, and such references mean “at least one”.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1-20. (canceled)

21. Adsorbent particles comprising amorphous silica, wherein:
a micropore surface area of the adsorbent particles is from about 150 m²/g to about 300 m²/g,
a relative micropore surface area (RMA) of the adsorbent particles is at least about 15%,
a total pore volume of the adsorbent particles for pores between 500 nm and 20000 nm in diameter, as measured via mercury porosimetry, is less than 5 mm³/g,
an average crush strength of the adsorbent particles is greater than about 60 N/bead, and
a tapped bulk density of the adsorbent particles is greater than 0.6 g/cm³.

22. The adsorbent particles of claim 21, wherein the adsorbent particles have a fluid-accessible average Brunauer-Emmett-Teller (BET) surface area of at least about 600 m²/g.

23. The adsorbent particles of claim 21, wherein the total pore volume for pores between 500 nm and 20000 nm in diameter, as measured via mercury porosimetry, is less than about 3 mm³/g.

24. The adsorbent particles of claim 23, wherein the tapped bulk density of the adsorbent particles is at least about 0.7 g/cm³.

25. The adsorbent particles of claim 24, wherein the RMA of the adsorbent particles is at least about 20%.

26. The adsorbent particles of claim 25, wherein an average diameter of the adsorbent particles is greater than about 1 mm to about 4 mm.

27. The adsorbent particles of claim 26, wherein the amorphous silica is present in an amount of at least about 80 wt. %, based on a total weight of the adsorbent particles, and wherein the adsorbent particles further comprise alumina.

28. A thermal swing adsorption system adapted for adsorption of one or more of water, C5+ components, or C6+ components from a fluid volume, the thermal swing adsorption system comprising:
an adsorber unit comprising an adsorbent bed, the adsorbent bed comprising:
adsorbent particles comprising amorphous silica, wherein:
a micropore surface area of the adsorbent particles is from about 150 m²/g to about 300 m²/g,
a relative micropore surface area (RMA) of the adsorbent particles is at least about 15%,
a total pore volume of the adsorbent particles for pores between 500 nm and 20000 nm in diameter, as measured via mercury porosimetry, is less than 5 mm³/g,
an average crush strength of the adsorbent particles is greater than about 60 N/bead, and
a tapped bulk density of the adsorbent particles is greater than 0.6 g/cm³.

29. The adsorbent particles of claim 28, wherein the adsorbent particles have a fluid-accessible average Brunauer-Emmett-Teller (BET) surface area of at least about 600 m²/g.

30. The thermal swing adsorption system of claim 28, wherein the total pore volume for pores between 500 nm and 20000 nm in diameter, as measured via mercury porosimetry, is less than about 3 mm³/g.

31. The thermal swing adsorption system of claim 30, wherein the tapped bulk density of the adsorbent particles is at least about 0.7 g/cm³.

32. The thermal swing adsorption system of claim 31, wherein the RMA of the adsorbent particles is at least about 20%.

33. The thermal swing adsorption system of claim 32, wherein an average diameter of the adsorbent particles is greater than about 1 mm to about 4 mm.

34. The thermal swing adsorption system of claim 33, wherein the amorphous silica is present in an amount of at least about 80 wt. %, based on a total weight of the adsorbent particles, and wherein the adsorbent particles further comprise alumina.

35. A method of purifying a natural gas stream via a thermal swing adsorption process, the method comprising:
directing the natural gas stream to an adsorber unit comprising adsorbent particles, the adsorbent particles comprising amorphous silica, wherein:
a micropore surface area of the adsorbent particles is from about 150 m²/g to about 300 m²/g,
a relative micropore surface area (RMA) of the adsorbent particles is at least about 15%,
a total pore volume of the adsorbent particles for pores between 500 nm and 20000 nm in diameter, as measured via mercury porosimetry, is less than 5 mm³/g,
an average crush strength of the adsorbent particles is greater than about 60 N/bead, and
a tapped bulk density of the adsorbent particles is greater than 0.6 g/cm³.

36. The method of claim 35, wherein the adsorbent particles have a fluid-accessible average Brunauer-Emmett-Teller (BET) surface area of at least about 600 m²/g.

37. The method of claim 35, wherein the total pore volume for pores between 500 nm and 20000 nm in diameter, as measured via mercury porosimetry, is less than about 3 mm³/g.

38. The method of claim 37, wherein the tapped bulk density of the adsorbent particles is at least about 0.7 g/cm³.

39. The method of claim 38, wherein the RMA of the adsorbent particles is at least about 20%.

40. The method of claim 39, wherein an average diameter of the adsorbent particles is greater than about 1 mm to about 4 mm, and wherein the amorphous silica is present in an amount of at least about 80 wt. %, based on a total weight of the adsorbent particles, and wherein the adsorbent particles further comprise alumina.
